(19) United States
(12) Patent Application Publication
(10) Pub. No.: US 2006/0142623 A1
(43) Pub. Date: Jun. 29, 2006

(54) Polyethylene wax, lost wax composition for precision casting containing the same, and method for forming model for precision casting

(75) Inventors: Masaki Yoda, Sodegaura-shi (JP); Hideo Toyoda, Sodegaura-shi (JP); Kojiro Kan, Sodegaura-shi (JP); Hirotaka Uosaki, Sodegaura-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Mitsui Chemicals, Inc., Minato-ku (JP)

(21) Appl. No.: 10/561,842

(22) PCT Filed: Jun. 21, 2004
(86) PCT No.: PCT/JP04/09050

§ 371 Date: Dec. 22, 2005

(30) Foreign Application Priority Data
Jun. 23, 2003 (JP) 2003-177923
Sep. 29, 2003 (JP) 2003-337536

(51) Int. Cl. C08L 91/06

(52) U.S. Cl. 585/9; 208/20

(57) ABSTRACT

Disclosed is a polyethylene wax defined by the features (i) to (iv): (i) said polyethylene wax is an ethylene homopolymer or a copolymer of ethylene and an α-olefin of 3 to 20 carbon atoms, (ii) a ratio (Mw/Mn) of the weight-average molecular weight (Mw) to the number-average molecular weight (Mn), as measured by GPC, is in the range of 1.7 to 4.0, (iii) the softening point is not higher than 125° C., and (iv) the penetration hardness is not more than 15 dmm. Also disclosed are a lost wax composition for precision casting, which comprises the polyethylene wax, and a method for forming a model for precision casting, which uses the lost wax composition for precision casting.

### TECHNICAL FIELD

The present invention relates to a polyethylene wax having low shrinkage ratio, high hardness and low tackiness, a lost wax composition used for forming a model for precision casting by a lost wax process, and a method for forming a model for precision casting using the lost wax composition.

### BACKGROUND ART

Polyethylene waxes are widely used for various dispersants, modifiers, ink additives, toner release agents for electrostatic copying, etc., and recently, polyethylene waxes having low shrinkage ratio, high hardness and low tackiness have been particularly desired in the applications to hot melts, lost waxes and the like.

By the way, as processes for preparing polyethylene waxes, there can be generally mentioned a high-pressure radical process, a medium/low-pressure process using a transition metal catalyst, such as Ziegler catalyst, metallocene catalyst or phenoxyimine catalyst, a process comprising heat degradation of a high-molecular weight olefin polymer, etc. (e.g., Japanese Patent Laid-Open Publication No. 132608/1989, Japanese Patent Laid-Open Publication No. 129303/1987, Japanese Patent Laid-Open Publication No. 002731/2001, Japanese Patent Laid-Open Publication No. 287609/1991). In these publications, polyethylene waxes comprising a copolymer of ethylene and an α-olefin are shown, but shrinkage ratio of the waxes and molecular weight distribution having great influence on the shrinkage ratio are not disclosed at all. In Japanese Patent Laid-Open Publication No. 129303/1987, a polyethylene wax having a narrow molecular weight distribution to reduce tackiness is disclosed, but the polyethylene wax merely having a narrow molecular weight distribution shows a very high shrinkage ratio, and such a polyethylene wax is unsuitable for the hot melts and the lost waxes. Further, whether such a polyethylene wax of specific composition merely having a low softening point and a low density as disclosed in Japanese Patent Laid-Open Publication No. 132608/1989 satisfies shrinkage property, hardness and tackiness required for the above uses is not clear.

In the manufacture of jet engine parts, nuclear reactor parts and general machine parts, precision casting by a lost wax process came to be more and more important recently. The process is generally carried out in the following manner. That is to say, first, a wax composition is poured into a mold to form a desired wax model, then the wax model is immersed in a slurry of a refractory, and before the slurry is dried, refractory particles are sprinkled to coat the wax model with the refractory particles. The operations of immersion and sprinkling are repeated to make the coating layer thick, and the wax model is coated with a final slurry and dried. Then, the wax model is melted by heating and discharged to form a casting mold. Into this casting mold, a molten metal is cast, and then operations of shake-out, gate cutting and finishing are carried out to form a product.

The model material (referred to as a “lost wax” hereinafter) used for the wax model in such precision casting by the lost wax process requires the following features because the production process has specificity and the product is a precision cast article. That is to say, (1) dimensional accuracy is high, that is, solidification shrinkage ratio and sink mark (depression of smooth surface) are small, (2) releasability from a mold is excellent, (3) surface texture of a wax model is excellent, that is, there are no flow lines (linear pattern due to wax flow inside a mold) and no involvement of bubbles during the injection molding, (4) fluidity is excellent and the molding temperature range is wide, (5) recovery after use and recycling of many times are feasible, (6) flexural strength is high, and (7) shell cracking does not occur in the formation of a casting mold.

The lost wax is a composition usually consisting of several kinds of materials, and examples of the materials include various waxes of animal type, vegetable type, petroleum type, mineral type and synthetic type, and resins, such as natural rosin, rosin derivatives and petroleum resins. In case of lost waxes hitherto used, however, the resulting models suffer large shrinkage and large sink mark and are brittle because of low flexural strength. Moreover, such lost waxes also have a drawback of poor releasability from a mold in the molding process. Therefore, it has been difficult to form a lost wax model of complicated shape and good surface condition with high dimensional accuracy.

For improving the above drawbacks, it has been already proposed to add various additives to the lost wax to enhance strength of the molded model and thereby prevent damages in the withdrawal from a mold. Examples of such additives include terephthalic acid, isophthalic acid, benzoic acid, naphthalene, fatty acid amide, polyhydric alcohols and their esters, such as pentaerythritol, organic compounds, such as bisphenol, powders or spheres of synthetic resins, such as polystyrene, polyethylene and polybutylene, and starch. These additives (referred to as “fillers” hereinafter) reduce solidification shrinkage and are effective for the improvement of sink mark to a certain extent. However, a phenomenon of cracking of a casting mold (shell cracking) frequently occurs when a wax model is melted and discharged to form a casting mold, and because of low fluidity, it has been difficult to efficiently produce cast articles.

### DISCLOSURE OF THE INVENTION

It is a first object of the present invention to provide a polyethylene wax capable of being favorably used for hot melts, lost waxes, etc. and having low shrinkage ratio, high hardness and low tackiness.

It is a second object of the present invention to provide a lost wax composition for precision casting which is used for efficiently producing cast articles of complicated shapes with high accuracy, and a method for forming a model for precision casting using the lost wax composition.

The present inventors have earnestly studied, and as a result, they have found that the first object is attained by a polyethylene wax having specific composition, molecular weight distribution, softening point and penetration hardness and the second object is attained by using the polyethylene wax as a component of a lost wax composition.

That is to say, the present invention is a polyethylene wax defined by the following features (i) to (iv):

(i) said polyethylene wax is an ethylene homopolymer or a copolymer of ethylene and at least one olefin selected from α-olefins of 3 to 20 carbon atoms,

(ii) a ratio (Mw/Mn) of the weight-average molecular weight (Mw) to the number-average molecular weight (Mn), as measured by gel permeation chromatography (GPC), is in the range of 1.7 to 4.0,

(iii) the softening point is not higher than 125° C., and

(iv) the penetration hardness is not more than 15 dmm.

The present invention is also a lost wax composition for precision casting, which comprises the above-mentioned polyethylene wax, and is also a method for forming a model for precision casting, which uses the lost wax composition.

### BRIEF DESCRIPTION OF THE DRAWINGS

FIG. 1 is a perspective view of a lost wax model for dimension measurement.

FIG. 2 is a perspective view of a lost wax model for sink mark measurement.

FIG. 3 is a perspective view of an impeller lost wax model for precision casting.

### DESCRIPTION OF SYMBOLS

a: front surface of mold

b: back surface of mold

1: shaft

2: gear

3: blade

4: bottom

### BEST MODE FOR CARRYING OUT THE INVENTION

The present invention is described in detail hereinafter.

The polyethylene wax of the invention is an ethylene homopolymer or a copolymer of ethylene and at least one olefin selected from α-olefins of 3 to 20 carbon atoms, and is preferably a copolymer of ethylene and at least one olefin selected from α-olefins of 3 to 20 carbon atoms. The α-olefins are preferably α-olefins of 3 to 10 carbon atoms, more preferably α-olefins of 3 to 8 carbon atoms, particularly preferably propylene, 1-butene, 1-hexene and 4-methyl-1-pentene.

The ratio (Mw/Mn) of a weight-average molecular weight (Mw) of the polyethylene wax of the invention to a number-average molecular weight (Mn) thereof, as measured by gel permeation chromatography (GPC), is in the range of 1.7 to 4.0, preferably 2.6 to 4.0, more preferably 2.6 to 3.5.

Further, the ratio (Mz/Mw) of a z-average molecular weight (Mz) of the polyethylene wax of the invention to a weight-average molecular weight (Mw) thereof, as measured by gel permeation chromatography (GPC), is preferably in the range of 1.5 to 2.0. When Mw/Mn and Mz/Mw of the polyethylene wax are in these ranges, the polyethylene wax has a good balance between shrinkage ratio and hardness and exhibits low tackiness.

The softening point of the polyethylene wax of the invention is not higher than 125° C., preferably not higher than 110° C., more preferably not higher than 105° C. When the softening point is in this range, the polyethylene wax has low shrinkage ratio and exhibits low viscosity at low temperatures, so that it can be favorably used for a hot melt, a lost wax and the like.

The penetration hardness of the polyethylene wax of the invention is not more than 15 dmm, preferably not more than 12 dmm, more preferably not more than 10 dmm. When the penetration hardness is not more than 15 dmm, the polyethylene wax has proper strength, so that it can be favorably used for a hot melt, a lost wax and the like.

The intrinsic viscosity [η] of the polyethylene wax of the invention, as measured in decalin at 135° C., is in range of preferably 0.15 to 0.50 dl/g, more preferably 0.20 to 0.40 dl/g. When [η] is in this range, the polyethylene wax has low tackiness, and if it is melted, it is easily handled because of low viscosity.

The density of the polyethylene wax of the invention, as measured by a density gradient tube method, is in the range of preferably 880 to 910 kg/m³, more preferably 890 to 905 kg/m³. When the density of the polyethylene wax is in this range, the polyethylene wax has a good balance between shrinkage ratio and hardness.

The acetone extraction quantity of a powder (about 2 mm square) of the polyethylene wax of the invention is preferably not more than 6% by weight, more preferably not more than 4% by weight. When the acetone extraction quantity is in this range, the polyethylene wax exhibits low tackiness. In the acetone extraction, extraction with boiling acetone was carried out for 5 hours using a Soxhlet's extractor.

Further, the polyethylene wax of the invention is preferably one having a softening point (Ts (° C.)) and a penetration hardness (Y (dmm)) which satisfy the following relationship (I). When the softening point (Ts (° C.)) and the penetration hardness (Y (dmm)) satisfy the following relationship (I), the polyethylene wax has an excellent balance between shrinkage ratio and strength, so that it can be favorably used for a hot melt, a lost wax and the like.
−0.53Ts+62>Y>−0.53Ts+53 (I)

As the polyethylene wax of the invention, also preferable is the following combination, that is:

a polyethylene wax which is a copolymer of ethylene and at least one olefin selected from α-olefins of 3 to 20 carbon atoms and has a ratio (Mw/Mn) of a weight-average molecular weight (Mw) to a number-average molecular weight (Mn), as measured by gel permeation chromatography (GPC), of 2.6 to 4.0, a softening point of not higher than 110° C., a penetration hardness of not more than 15 dmm, an intrinsic viscosity [η], as measured in decalin at 135° C., of 0.15 to 0.50 dl/g, a ratio (Mz/Mw) of a z-average molecular weight (Mz) to a weight-average molecular weight (Mw), as measured by gel permeation chromatography (GPC), of 1.5 to 2.0, a density of 880 to 910 kg/m³ and an acetone extraction quantity of not more than 6% by weight, wherein the softening point (Ts (° C.)) and the penetration hardness (Y (dmm)) satisfy the following relationship (I):
−0.53Ts+62>Y>−0.53Ts+53 (I),

and

a polyethylene wax which is an ethylene homopolymer or a copolymer of ethylene and at least one olefin selected from α-olefins of 3 to 20 carbon atoms and has a ratio (Mw/Mn) of a weight-average molecular weight (Mw) to a number-average molecular weight (Mn), as measured by gel permeation chromatography, of 1.7 to 3.3, a softening point of 88 to 125° C., a penetration hardness of not more than 7 dmm and an intrinsic viscosity [η], as measured in decalin at 135° C., of 0.05 to 0.20 dl/g.

Next, the lost wax composition of the invention is described in detail.

As components of the lost wax composition of the invention other than a polyethylene wax, resins usually used are employable without any restriction, and examples of such resins include various waxes of animal type, vegetable type, petroleum type, mineral type and synthetic type, alicyclic hydrogerated tackifiers, rosin resins, modified rosin resins or their esterification products, aliphatic petroleum resins, alicyclic petroleum resins, aromatic petroleum resins, copolymerization petroleum resins of aliphatic components and aromatic components, low-molecular weight styrene resins, isoprene resins, alkylphenol resins, terpene resin and coumarone-indene resin. In the present invention, these resins other than a polyethylene wax can be used singly or in combination of two or more kinds.

As a polyethylene wax for use in the lost wax composition for precision casting of the invention, the polyethylene wax of the invention is employed. That is to say, an ethylene homopolymer or a copolymer of ethylene and at least one olefin selected from α-olefins of 3 to 20 carbon atoms is employed. Of the ethylene homopolymer and the copolymer, an ethylene/α-olefin copolymer is preferably employed. As the α-olefin, preferable is an α-olefin of 3 to 10 carbon atoms, more preferable is an α-olefin of 3 to 8 carbon atoms, and particularly preferable is propylene, 1-butene, 1-hexene or 4-methyl-1-pentene.

When the polyethylene wax is an ethylene copolymer, constituent units derived from ethylene are desirably contained in amounts of usually 80 to 99% by mol, preferably 90 to 99% by mol. If the polyethylene wax is an ethylene copolymer and if the amounts of the constituent units derived from ethylene are in the above range, a lost wax obtained by the use of this polyethylene wax has satisfactory hardness.

The ratio (Mw/Mn) of a weight-average molecular weight (Mw) of the polyethylene wax to a number-average molecular weight (Mn) thereof, as measured by gel permeation chromatography (GPC), is in the range of 1.7 to 4.0, preferably 1.7 to 3.3. When Mw/Mn is in this range, a lost wax obtained by the use of this polyethylene wax has excellent dimensional accuracy and the resulting wax model has high flexural strength.

The softening point of the polyethylene wax is not higher than 125° C., preferably 88 to 125° C., more preferably 90 to 110° C., still more preferably 95 to 105° C. When the softening point is in this range, a lost wax obtained by the use of this polyethylene wax exhibits excellent moldability in a wide temperature range, and a wax model formed has excellent flexural strength and surface texture.

The penetration hardness of the polyethylene wax is not more than 15 dmm, preferably not more than 7 dmm, more preferably not more than 4 dmm. When the penetration hardness is not more than 15 dmm, a lost wax model obtained by the use of this polyethylene wax has satisfactory flexural strength.

The intrinsic viscosity [η] of the polyethylene wax, as measured in decalin at 135° C., is desired to be in the range of usually 0.05 to 0.20 dl·g⁻¹, preferably 0.07 to 0.15 dl·g⁻¹. When the intrinsic viscosity [η] is in this range, the polyethylene wax has a proper melt viscosity, so that a lost wax obtained by the use of this polyethylene wax has high fluidity and excellent moldability. If [η] is more than 0.20 dl/g, fluidity is lowered, and for example, in the case where a lost wax is injected into a mold in the injection molding, it becomes difficult to sufficiently fill a narrow part of the mold with the lost wax, and as a result, a defect of a wax model is liable to occur. If [η] is less than 0.05 dl/g, it becomes difficult to obtain a lost wax model having satisfactory strength.

Further, the polyethylene wax desirably has an acid value of not more than 5 KOH·mg/g. When the acid value is in this range, shell cracking rarely occurs in the formation of a casting mold. If the acid value is more than 5 KOH·mg/g, a lost wax obtained by the use of this polyethylene wax develops strong odor and has poor workability.

The polyethylene wax having such an acid value can be obtained by oxidizing a polyethylene wax, which is obtained by the use of a Ziegler catalyst, a metallocene catalyst or the like, in accordance with a publicly known oxidation method (e.g., Japanese Patent Laid-Open Publication No. 80252/1999).

Examples of processes for preparing the ethylene homopolymer and the ethylene copolymer of the invention are described below, but the process employable is not limited thereto. For example, they can be prepared by the use of such a metallocene catalyst comprising a metallocene compound of a transition metal selected from Group 4 of the periodic table, and an organoaluminum oxy-compound and/or an ionizing ionic compound as mentioned below.

Metallocene Compound

The metallocene compound for forming the metallocene catalyst is a metallocene compound of a transition metal selected from Group 4 of the periodic table, and an example thereof is a compound represented by the following formula (1).
M¹Lₓ (1)

In the above formula, M¹ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group, alkyl or cycloalkyl substituted cyclopentadienyl groups, such as methylcyclopentadienyl, ethylcyclopentadienyl, n- or i-propylcyclopentadienyl, n-, i-, sec-, or t-butylcyclopentadienyl, dimethylcyclopentadienyl, methylpropylcyclopentadienyl, methylbutylcyclopentadienyl and methylbenzylcyclopentadienyl, an indenyl group, a 4,5,6,7-tetrahydroindenyl group and a fluorenyl group. In these ligands having cyclopentadienyl skeleton, hydrogen may be replaced with a halogen atom, a trialkylsilyl group or the like.

When the metallocene compound has two or more ligands having cyclopentadienyl skeleton as ligands L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group of 1 to 12 carbon atoms, an alkoxy group, an aryloxy group, a sulfonic acid-containing group (—SO₃R¹ wherein R¹ is an alkyl group, an alkyl group substituted with a halogen atom, an aryl group, an aryl group substituted with a halogen atom, or an aryl group substituted with an alkyl group), a halogen atom or a hydrogen atom.

Example 1 of Metallocene Compound

When the metallocene compound represented by the above formula (1) has a transition metal valence of, for example, 4, this metallocene compound is more specifically represented by the following formula (2):
R²ₖR³ₗR⁴ₘR⁵ₙM¹ (2)
wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+l+m+n=4.

Examples of the metallocene compounds having zirconium as M¹ and having at least two ligands having cyclopentadienyl skeleton include bis(cyclopentadienyl)zirconium monochloride monohydride, bis(cyclopentadienyl)zirconium dichloride, bis(1-methyl-3-butylcyclopentadienyl)zirconium-bis(trifluoromethanesulfonate) and bis(1,3-dimethylcyclopentadienyl)zirconium dichloride.

Also employable are compounds wherein the 1,3-position substituted cyclopentadienyl group in the above compounds is replaced with a 1,2-position substituted cyclopentadienyl group.

As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group or the like is also employable. In this case, R⁴ and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl)zirconium dichloride and methylphenylsilylenebis(indenyl)zirconium dichloride.

Example 2 of Metallocene Compound

Another example of the metallocene compound is a metallocene compound represented by the following formula (3) that is described in Japanese Patent Laid-Open Publication No. 268307/1992.

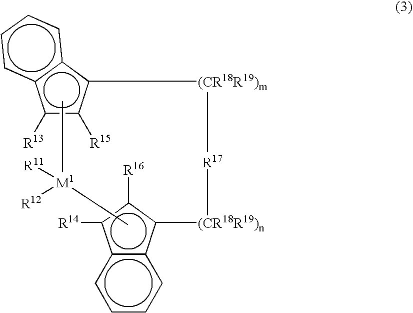

In the above formula, M¹ is a transition metal of Group 4 of the periodic table, specifically titanium, zirconium or hafnium.

R¹¹ and R¹² may be the same as or different from each other and are each a hydrogen atom, an alkyl group of 1 to 10 carbon atoms, an alkoxy group of 1 to 10 carbon atoms, an aryl group of 6 to 10 carbon atoms, an aryloxy group of 6 to 10 carbon atoms, an alkenyl group of 2 to 10 carbon atoms, an arylalkyl group of 7 to 40 carbon atoms, an alkylaryl group of 7 to 40 carbon atoms, an arylalkenyl group of 8 to 40 carbon atoms or a halogen atom. R¹¹ and R¹² are each preferably a chlorine atom.

R¹³ and R¹⁴ may be the same as or different from each other and are each a hydrogen atom, a halogen atom, an alkyl group of 1 to 10 carbon atoms which may be halogenated, an aryl group of 6 to 10 carbon atoms, or a group of —N(R²⁰)₂, —SR²⁰, —OSi (R²⁰)₃, —Si (R²⁰)₃ or —P(R²⁰)₂. R²⁰ is a halogen atom, preferably a chlorine atom, an alkyl group of 1 to 10 carbon atoms (preferably 1 to 3 carbon atoms) or an aryl group of 6 to 10 carbon atoms (preferably 6 to 8 carbon atoms). R¹³ and R¹⁴ are each particularly preferably a hydrogen atom.

R¹⁵ and R¹⁶ are the same as R¹³ and R¹⁴, except that a hydrogen atom is not included, and they may be the same as or different from each other, preferably the same as each other. R¹⁵ and R¹⁶ are each preferably an alkyl group of 1 to 4 carbon atoms which may be halogenated, specifically methyl, ethyl, propyl, isopropyl, butyl, isobutyl, trifluoromethyl or the like, particularly preferably methyl.

In the formula (3), R¹⁷ is selected from the following group. 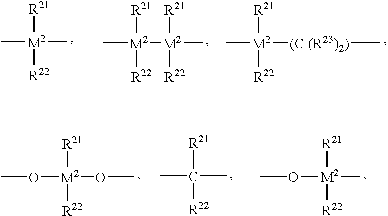
═BR²¹, ═AlR²¹, —Ge—, —Sn—, —O—, —S—, ═SO, ═SO₂, ═NR²¹, ═CO, ═PR²¹, ═P(O)R²¹, etc.

M² is silicon, germanium or tin, preferably silicon or germanium. R²¹, R²² and R²³ may be the same as or different from one another and are each a hydrogen atom, a halogen atom, an alkyl group of 1 to 10 carbon atoms, a fluoroalkyl group of 1 to 10 carbon atoms, an aryl group of 6 to 10 carbon atom, a fluoroaryl group of 6 to 10 carbon atoms, an alkoxy group of 1 to 10 carbon atoms, an alkenyl group of 2 to 10 carbon atoms, an arylalkyl group of 7 to 40 carbon atoms, an arylalkenyl group of 8 to 40 carbon atoms, or an alkylaryl group of 7 to 40 carbon atoms. “R²¹ and R²²” or “R²¹ and R²³” may form a ring together with atoms to which they are bonded. R¹⁷ is preferably ═CR²¹R²², ═SiR²¹R²², ═GeR²¹R²², —O—, —S—, ═SO, ═PR²¹ or ═P(O)R²¹. R¹⁸ and R¹⁹ may be the same as or different from each other and are each the same atom or group as that of R²¹. m and n may be the same as or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride and rac-dimethylsilylene (2-methyl-1-indenyl)₂-zirconium dichloride. These metallocene compounds can be prepared by, for example, a process described in Japanese Patent Laid-Open Publication No. 268307/1992.

Example 3 of Metallocene Compound

As the metallocene compound, a metallocene compound represented by the following formula (4) is also employable.

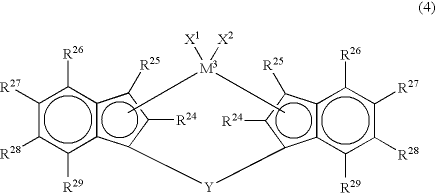

In the formula (4), M³ is a transition metal atom of Group 4 of the periodic table, specifically titanium, zirconium or hafnium. R²⁴ and R²⁵ may be the same as or different from each other and are each a hydrogen atom, a halogen atom, a hydrocarbon group of 1 to 20 carbon atoms, a halogenated hydrocarbon group of 1 to 20 carbon atoms, a silicon-containing group, an oxygen-containing group, a sulfur-containing group, a nitrogen-containing group or a phosphorus-containing group. R²⁴ is preferably a hydrocarbon group, particularly preferably an alkyl group of 1 to 3 carbon atoms, i.e., methyl, ethyl or propyl. R²⁵ is preferably a hydrogen atom or hydrocarbon group, particularly preferably a hydrogen atom or an alkyl group of 1 to 3 carbon atoms, i.e., methyl, ethyl or propyl. R²⁶, R²⁷, R²⁸ and R²⁹ may be the same as or different from one another and are each a hydrogen atom, a halogen atom, a hydrocarbon group of 1 to 20 carbon atoms or a halogenated hydrocarbon group of 1 to 20 carbon atoms. Of these, preferable is a hydrogen atom, a hydrocarbon group or a halogenated hydrocarbon group. At least one combination of “R²⁶ and R²⁷”, “R²⁷ and R²⁸”, and “R²⁸ and R²⁹” may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁰—, —P(R³⁰)—, —P(O)(R³⁰)—, —BR³⁰— or —AlR³⁰— (R³⁰ is a hydrogen atom, a halogen atom, a hydrocarbon group of 1 to 20 carbon atoms or a halogenated hydrocarbon group of 1 to 20 carbon atoms).

Examples of the ligands in the formula (4) which have a monocyclic aromatic ring formed by mutual bonding of at least one combination of “R²⁶ and R²⁷”, “R²⁷ and R²⁸”, and “R²⁸ and R²⁹” and which are coordinated to M³ include those represented by the following formulas: 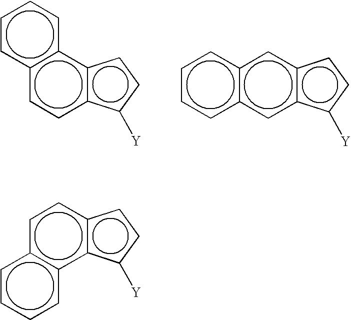
wherein Y is the same as that described in the above-mentioned formula.
Example 4 of Metallocene Compound

As the metallocene compound, a metallocene compound represented by the following formula (5) is also employable.

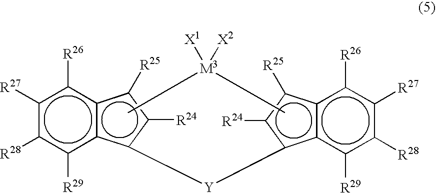

In the formula (5), M³, R²⁴, R²⁵, R²⁶, R²⁷, R²⁸ and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸ and R²⁹, groups other than the alkyl group are each preferably a hydrogen atom. Two groups selected from R²⁶, R²⁷, R²⁸ and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride and rac-dimethylsilylene-bis(2,4,6-trimethyl-1-indenyl)zirconium dichloride.

Also employable are transition metal compounds wherein the zirconium metal is replaced with a titanium metal or a hafnium metal in the above compounds. The transition metal compound is usually used as a racemic modification, but R form or S form is also employable.

Example 5 of Metallocene Compound

As the metallocene compound, a metallocene compound represented by the following formula (6) is also employable.

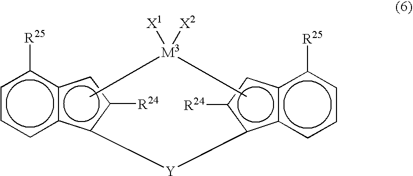

In the formula (6), M³, R²⁴, X¹, X² and Y are the same as those in the formula (4). R²⁴ is preferably a hydrocarbon group, particularly preferably an alkyl group of 1 to 4 carbon atoms, i.e., methyl, ethyl, propyl or butyl. R²⁵ is an aryl group of 6 to 16 carbon atoms. R²⁵ is preferably phenyl or naphthyl. The aryl group may be substituted with a halogen atom, a hydrocarbon group of 1 to 20 carbon atoms or a halogenated hydrocarbon group of 1 to 20 carbon atom. X¹ and X² are each preferably a halogen atom or a hydrocarbon group of 1 to 20 carbon atoms.

Examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride and rac-dimethylsilylene-bis(2-methyl-4-(1-anthryl)-1-indenyl)zirconium dichloride.

Also employable are transition metal compounds wherein the zirconium metal is replaced with a titanium metal or a hafnium metal in the above compounds.

Example 6 of Metallocene Compound

As the metallocene compound, a metallocene compound represented by the following formula (7) is also employable.
LaM⁴X³₂ (7)

In the above formula, M⁴ is a metal of Group 4 or lanthanide series of the periodic table. La is a derivative of a delocalized π bond group and is a group imparting a constraint geometric shape to the metal M⁴ active site. Each X³ may be the same or different and is a hydrogen atom, a halogen atom, a hydrocarbon group of 20 or less carbon atoms, a silyl group having 20 or less silicon atoms or a germyl group having 20 or less germanium atoms.

Of such compounds, a compound represented by the following formula (8) is preferable.

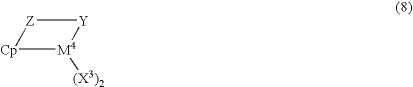

In the formula (8), M⁴ is titanium, zirconium or hafnium. X³ is the same as that described in the formula (7). Cp is π-bonded to M⁴ and is a substituted cyclopentadienyl group having a substituent Z. Z is oxygen, sulfur, boron or an element of Group 4 of the periodic table (e.g., silicon, germanium or tin). Y is a ligand having nitrogen, phosphorus, oxygen or sulfur, and Z and Y may together form a condensed ring.

Examples of the metallocene compounds represented by the formula (8) include:

(dimethyl(t-butylamido)(tetramethyl-η⁵-cyclopentadienyl)silane)titanium dichloride and ((t-butylamido) (tetramethyl-η⁵-cyclopentadienyl)-1,2-ethanediyl)titanium dichloride.

Also employable are metallocene compounds wherein titanium is replaced with zirconium or hafnium in the above compounds.

Example 7 of Metallocene Compound

As the metallocene compound, a metallocene compound represented by the following formula (9) is also employable.

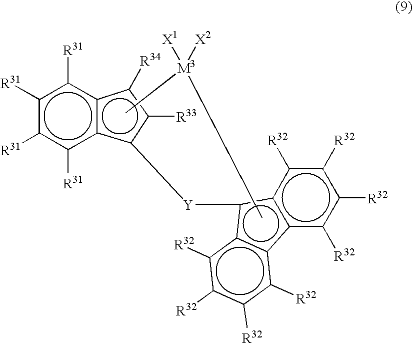

In the formula (9), M³ is a transition metal atom of Group 4 of the periodic table, specifically titanium, zirconium or hafnium, preferably zirconium. Each R³¹ may be the same or different, and at least one of them is an aryl group of 11 to 20 carbon atoms, an arylalkyl group of 12 to 40 carbon atoms, an arylalkenyl group of 13 to 40 carbon atoms, an alkylaryl group of 12 to 40 carbon atoms or a silicon-containing group, or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group or an alkylaryl group or that forms an aromatic ring or an aliphatic ring is a hydrogen atom, a halogen atom, an alkyl group of 1 to 10 carbon atoms or a silicon-containing group. Each R³² may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group of 1 to 10 carbon atoms or a silicon-containing group. In the groups constituted of single or plural aromatic rings or aliphatic rings formed by two groups indicated by R³², an embodiment wherein the fluorenyl group part has such a structure as represented by the following formula is included.

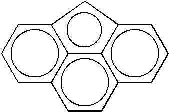

R³² is preferably a hydrogen atom or an alkyl group, particularly preferably a hydrogen atom or a hydrocarbon group of 1 to 3 carbon atoms, i.e., methyl, ethyl or propyl. A preferred example of the fluorenyl group having R³² as such a substituent is a 2,7-dialkyl-fluorenyl group, and in this case, an alkyl group of the 2,7-dialkyl is, for example, an alkyl group of 1 to 5 carbon atoms. R³¹ and R³² may be the same as or different from each other. R³³ and R³⁴ may be the same as or different from each other and are each a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, and arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group, similarly to the above. At least one of R³³ and R³⁴ is preferably an alkyl group of 1 to 3 carbon atoms. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group of 1 to 10 carbon atoms. X¹ and X² are each preferably a halogen atom, a hydrocarbon group of 1 to 20 carbon atoms or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group of 1 to 20 carbon atoms or a halogenated hydrocarbon group of 1 to 20 carbon atoms). Of these divalent groups, preferable are those wherein the shortest linkage part of —Y— is constituted of one or two atoms. R³⁵ is a halogen atom, a hydrocarbon group of 1 to 20 carbon atoms or a halogenated hydrocarbon group of 1 to 20 carbon atoms. Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

Example 8 of Metallocene Compound

As the metallocene compound, a metallocene compound represented by the following formula (10) is also employable.

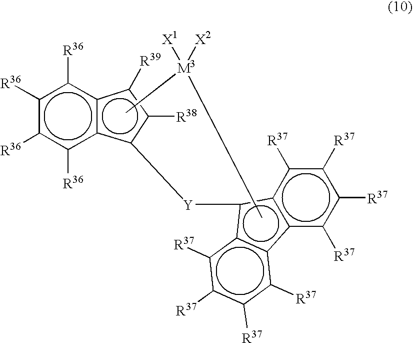

In the formula (10), M³ is a transition metal atom of Group 4 of the periodic table, specifically titanium, zirconium or hafnium, preferably zirconium. Each R³⁶ may be the same or different and is a hydrogen atom, a halogen atom, an alkyl group of 1 to 10 carbon atoms, an aryl group of 6 to 10 carbon atoms, an alkenyl group of 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group of 1 to 3 carbon atoms, i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. R³⁷ is preferably a hydrogen atom or an alkyl group, particularly preferably a hydrogen atom or a hydrocarbon group of 1 to 4 carbon atoms, i.e., methyl, ethyl, n-propyl, i-propyl, n-butyl or tert-butyl. R³⁶ and R³⁷ may be the same as or different from each other. One of R³⁸ and R³⁹ is an alkyl group of 1 to 5 carbon atoms, and the other is a hydrogen atom, a halogen atom, an alkyl group of 1 to 10 carbon atoms, an alkenyl group of 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group of 1 to 3 carbon atoms, such as methyl, ethyl or propyl, and the other is a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. X¹ and X² are each preferably a halogen atom or a hydrocarbon group of 1 to 20 carbon atoms. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR⁴⁰—, —P(R⁴⁰)—, —P(O)(R⁴⁰)—, —BR⁴⁰— or —AlR⁴⁰— (R⁴⁰ is a hydrogen atom, a halogen atom, a hydrocarbon group of 1 to 20 carbon atoms or a halogenated hydrocarbon group of 1 to 20 carbon atoms). Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

The metallocene compounds described above are used singly or in combination of two or more kinds.

The metallocene compounds may be used after diluted with hydrocarbon, halogenated hydrocarbon or the like.

Organoaluminum Oxy-Compound

The organoaluminum oxy-compound may be aluminoxane publicly known or a benzene-insoluble organoaluminum oxy-compound. Such publicly known aluminoxane is represented by the following formulas.

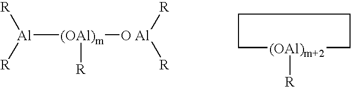

In the above formulas, R is a hydrocarbon group, such as methyl, ethyl, propyl or butyl, preferably methyl or ethyl, particularly preferably methyl. m is an integer of 2 or greater, preferably 5 to 40.

The aluminoxane may be constituted of mixed alkyloxyaluminum units comprising an alkyloxyaluminum unit represented by the formula (OAl(R′)) and an alkyloxyaluminum unit represented by the formula (OAl(R″)) (examples of R′ and R″ include the same hydrocarbon groups as described with respect to R, and R′ and R″ are groups different from each other). The organoaluminum oxy-compound may contain a small amount of an organic compound component of a metal other than aluminum.

Ionizing Ionic Compound

The ionizing ionic compound (sometimes referred to as an “ionic ionizing compound” or an “ionic compound”) is, for example, Lewis acid, an ionic compound, a borane compound or a carborane compound. The Lewis acid is, for example, a compound represented by BR₃ (R is a phenyl group which may have a substituent, such as fluorine, methyl or trifluoromethyl, or a fluorine atom). Examples of the Lewis acids include trifluoroboron, triphenylboron, tris(4-fluorophenyl)boron, tris(3,5-difluorophenyl)boron, tris(4-fluoromethylphenyl)boron, tris(pentafluorophenyl)boron, tris(p-tolyl)boron, tris(o-tolyl)boron and tris(3,5-dimethylphenyl)boron.

Examples of the ionic compounds include trialkyl substituted ammonium salts, N,N-dialkylanilinium salts, dialkylammonium salts and triarylphosphonium salts. Examples of the trialkyl substituted ammonium salts as the ionic compounds include triethylammonium tetra(phenyl)boron, tripropylammonium tetra(phenyl)boron and tri(n-butyl)ammonium tetra(phenyl)boron. Examples of the dialkylammonium salts as the ionic compounds include di(1-propyl)ammonium tetra(pentafluorophenyl)boron and dicyclohexylammonium tetra(phenyl)boron.

Also employable as the ionic compounds are triphenylcarbenium tetrakis(pentafluorophenyl)borate, N,N-dimethylanilinium tetrakis(pentafluorophenyl)borate and ferrocenium tetra(pentafluorophenyl)borate.

Examples of the borane compounds include decaborane(9), bis[tri(n-butyl)ammonium]nonaborate, bis[tri(n-butyl)ammonium]decaborate and salts of metallic borane anions, such as bis[tri(n-butyl)ammonium]bis(dodecahydridododecaborato)nickelate(III).

Examples of the carborane compounds include 4-carbanonaborane(9), 1,3-dicarbanonaborane(8), and salts of metallic carborane anions, such as bis[tri(n-butyl)ammonium]bis(undecahydrido-7-carbaundecaborato)nickelate(IV).

The ionizing ionic compounds described above are used singly or in combination of two or more kinds.

For forming the metallocene catalyst, such an organoaluminum compound as described below may be used together with the organoaluminum oxy-compound and/or the ionizing ionic compound.

Organoaluminum Compound

As the organoaluminum compound that is used when need, a compound having at least one Al-carbon bond in a molecule is employable. Examples of such compounds include:

an oragnoaluminum compound represented by the following formula (11):
(R⁶)ₘAl(OR⁷)ₙHₚX⁴_{q} (11)
wherein R⁶ and R⁷ may be the same as or different from each other and are each a hydrocarbon group of usually 1 to 15 carbon atoms, preferably 1 to 4 carbon atoms, X⁴ is a halogen atom, and m, n, p and q are numbers satisfying the conditions of 0<m≦3, 0≦n<3, 0≦p<3, 0≦q<3 and m+n+p+q=3,

and

an alkyl complex compound of a Group 1 metal and aluminum, which is represented by the following formula (12):
(M⁵)Al(R⁶) (12)
wherein M⁵ is Li, Na or K, and R⁶ is the same as R⁶ in the formula (11).
Polymerization

The polyethylene wax of the invention is obtained by homopolymerizing ethylene usually in a liquid phase or homopolymerizing or copolymerizing ethylene and at least one α-olefin selected from α-olefins of 3 to 10 carbon atoms usually in a liquid phase, in the presence of the above-mentioned metallocene catalyst. In the polymerization, a hydrocarbon solvent is generally used, but in case of copolymerization, an α-olefin may be used as a solvent. The monomers used herein are as previously described.

As the polymerization process, suspension polymerization wherein polymerization is carried out in such a state that the polyethylene wax is present as particles in a solvent such as hexane, or gas phase polymerization wherein a solvent is not used, or solution polymerization wherein polymerization is carried out at a polymerization temperature of not lower than 140° C. in such a state that the polyethylene wax is molten in the presence of a solvent or is molten alone is employable. Of these, solution polymerization is preferable in both aspects of economy and quality.

The polymerization reaction may be carried out as any of a batch process and a continuous process. When the polymerization is carried out as a batch process, the aforesaid catalyst components are used in the concentrations described below. The concentration of the metallocene compound in the polymerization system is in the range of usually 0.00005 to 0.1 mmol/liter (polymerization volume), preferably 0.0001 to 0.05 mmol/liter. The organoaluminum oxy-compound is fed in such an amount that the molar ratio of an aluminum atom to the transition metal of the metallocene compound in the polymerization system (Al/transition metal) is in the range of 1 to 10000, preferably 10 to 5000. The ionizing ionic compound is fed in such an amount that the molar ratio of the ionizing ionic compound to the metallocene compound in the polymerization system (ionizing ionic compound/metallocene compound) is in the range of 0.5 to 20, preferably 1 to 10. When the organoaluminum compound is used, the amount of the organoaluminum compound is in the range of usually about 0 to 5 mmol/liter (polymerization volume), preferably about 0 to 2 mmol/liter.

The polymerization reaction is carried out under the conditions of a temperature of usually −20 to 150° C., preferably 0 to 120° C., more preferably 0 to 100° C., and a pressure of more than 0 and not more than 7.8 MPa (80 kgf/cm², gauge pressure), preferably more than 0 and not more than 4.9 MPa (50 kgf/cm², gauge pressure). In the polymerization, ethylene and an α-olefin that is used when needed are fed to the polymerization system in such amounts that a polyethylene wax of the aforesaid specific composition is obtained. In the polymerization, further, a molecular weight modifier such as hydrogen can be added. When polymerization is carried out in this manner, a polymer produced is usually obtained as a polymerization solution containing the polymer. Therefore, by treating the polymerization solution in the usual way, a polyethylene wax is obtained. In the polymerization reaction, it is particularly preferable to use a catalyst containing the metallocene compound described in “Example 6 of metallocene compound”.

As a lost wax for use in the lost wax composition for precision casting of the invention, a polyethylene wax is preferably employed, and an ethylene/α-olefin copolymer is more preferably employed. The polyethylene wax is added in an amount of usually 5 to 50% by weight, preferably 5 to 20% by weight, based on the lost wax composition. If the amount of the polyethylene wax is less than 5% by weight, the resulting lost wax model does not have sufficient strength and exhibits bad surface texture. If the amount thereof exceeds 50% by weight, releasability from a mold becomes poor in the formation of a lost wax model and shell cracking frequently occurs, and besides, the resulting lost wax model has undesirable dimensional stability. If the amount of the polyethylene wax is increased within the quantity region of the polyethylene wax according to the invention, dimensional stability and sink mark are improved, flexural strength is increased, and surface texture is enhanced, in general.

As other components than the polyethylene wax in the lost wax composition for precision casting of the invention, resins usually used are employable without any restriction. Examples of such resins include various waxes of animal type, vegetable type, petroleum type, mineral type and synthetic type, alicyclic hydrogenated tackifiers, rosin resins, modified rosin resins or their esterification products, aliphatic petroleum resins, alicyclic petroleum resins, aromatic petroleum resins, copolymerization petroleum resins of aliphatic components and aromatic components, low-molecular weight styrene resins, isoprene resins, alkylphenol resins, terpene resin and coumarone-indene resin. In the present invention, these resins other than the polyethylene wax can be used singly or in combination of two or more kinds.

In general, the polyethylene wax-containing lost wax composition for precision casting of the invention is injected into a mold to prepare a lost wax model by injection molding or the like. This lost wax model exhibits low solidification shrinkage ratio and small sink mark, has stable dimensional accuracy and has high flexural strength, so that it can be used also as a relatively large lost wax model without hindrance. Moreover, the lost wax model exhibits smooth surface texture almost free from not only wrinkle due to flow line but also involvement of bubbles, so that the lost wax model greatly contributes to quality enhancement of the manufactured articles. Further, it is possible to recover the lost wax composition after use and to recycle its base wax many times.

The lost wax model obtained as above is immersed in a slurry of a refractory by a conventional method, and before the slurry is dried, refractory particles are sprinkled to coat the wax model with the refractory particles. Such operations are repeated, and the wax model is coated with a final slurry and then dried as it is or with backing up by setting it in a casting frame. Thereafter, the wax composition inside is melted by heating and discharged to form a cavity of original shape (formation of casting mold), and the casting mold is burned. Then, a molten metal is cast into the casting mold, and operations of solidification, shake-out, gate cutting and finishing are carried out to obtain a desired precision cast article. By the use of the polyethylene wax-containing lost wax model of the invention, a precision cast article can be obtained without occurrence of shell cracking, because the thermal expansion coefficient is low when the lost wax model is melted and discharged to form a casting mold.

### EXAMPLES

The present invention is further described with reference to the following examples, but it should be construed that the invention is in no way limited to those examples. Unless otherwise noted, the term “part(s)” described in the following examples means “part(s) by weight”.

Properties of the polyethylene waxes described below were measured in the following manner.

Intrinsic viscosity [η]

Intrinsic viscosity [η] was measured in accordance with ASTM D1601.

Mw/Mn

Weight-average molecular weight (Mw) and number-average molecular weight (Mn) were measured by GPC, and a ratio (Mw/Mn) of the weight-average molecular weight (Mw) to the number-average molecular weight (Mn) was evaluated. As a measuring device for GPC, Alliance 2000 (manufactured by Waters Co.) was used; as columns, TSK gel, GMH₆−HT×2+TSK gel and GMH₆−HTL×2 (each: 7.5 mm (I.D.)×30 cm, available from Tosoh Corporation) were used; and as a mobile phase, o-dichlorobenzene (available from Wako Pure Chemical Industries, Ltd., special grade reagent) was used. The measurement was carried out under the conditions of a column temperature of 140° C. and a mobile phase flow rate of 1.0 ml/min, and for the detection, a differential refractive index detector was used. For the molecular weight calibration, monodisperse polystyrene was used.

Mz/Mw

In a manner similar to that for the above Mw/Mn, a ratio (Mz/Mw) of a z-average molecular weight (Mz) to a weight-average molecular weight (Mw) was evaluated.

Density

Density was measured in accordance with JIS K6760.

Softening Point

Softening point was measured in accordance with JIS K2207.

Shrinkage Ratio

A polyethylene wax melted at 180° C. was poured into a mold (rectangular parallelepiped of about 12 cm (X)×about 1 cm (Y)×about 1 cm (Z)) and allowed to stand for 24 hours as it is in a constant temperature room at 25° C. Then, the solidified polyethylene wax was withdrawn to give a model for dimension measurement. The length of the X part of the model for dimension measurement was measured by a slide gauge, and from a difference between the measured length and the dimension of the mold, a shrinkage ratio was determined.

Penetration Hardness

Penetration hardness was measured in accordance with JIS K2207.

Acetone Extraction Quantity

Acetone extraction quantity was measured in the following manner. First, about 10 g of a polyethylene wax powder (about 2 mm square) was added to a cylindrical filter paper (ADVANTEC No-84) and weighed. Then, zeolite was placed in a 200 ml round-bottom flask and weighed. In the flask, 150 ml of acetone was introduced, and Soxhlet's extraction was carried out for 5 hours. The extraction liquid was evaporated, and after the evaporation, the round-bottom flask and the cylindrical filter paper containing the extraction residue were dried for about 3 hours by a vacuum dryer set at 80° C. The round-bottom flask containing the extract and the cylindrical filter paper with the extraction residue were each weighed. From the results, the extraction quantity was calculated.

Melt Viscosity

Melt viscosity of a wax was measured at 140° C. by the use of a Brookfield viscometer.

Acid Value

Acid value was measured in accordance with JIS K5902.

### Example 1

Using a metallocene catalyst, a polyethylene wax was synthesized in the following manner. In a 2-liter SUS autoclave thoroughly purged with nitrogen, 920 ml of hexane and 80 ml of 1-butene were placed, and hydrogen was fed until the pressure became 0.95 kg/cm² (gauge pressure). Subsequently, the temperature in the system was raised to 150° C., and then, 0.3 mmol of triisobutylaluminum, 0.004 mmol of triphenylcarbenium tetrakis(pentafluorophenyl)borate and 0.02 mmol of (t-butylamido)dimethyl(tetramethyl-η⁵-cyclopentadienyl)silanetitanium dichloride (available from Sigma Aldrich Corporation) were forced into the autoclave with ethylene to initiate polymerization. Thereafter, only ethylene was continuously fed to maintain the total pressure at 30 kg/cm² (gauge pressure), and polymerization was performed at 150° C. for 20 minutes.

After a small amount of ethanol was added to the system to terminate the polymerization, the unreacted ethylene and 1-butene were purged away. The resulting polymer solution was dried overnight at 100° C. under reduced pressure. As a result, 42.5 of a polyethylene wax (sample 1) having [η] of 0.24 dl/g, Mw/Mn of 3.1, Mz/Mw of 1.6, a density of 902 kg/m³, a softening point of 98° C., an acetone extraction quantity of 4.4% by weight, a penetration hardness of 6 dmm and a shrinkage ratio of 0.70 as shown in Table 1 was obtained.

### Example 2

Polymerization was carried out in the same manner as in Example 1, except that 910 ml of hexane and 90 ml of 1-butne were placed and hydrogen was fed until the pressure became 0.88 kg/cm² (gauge pressure). As a result, 36.2 g of a polyethylene wax (sample 2) having [η] of 0.39 dl/g, Mw/Mn of 3.6, Mz/Mw of 1.7, a density of 895 kg/m³, a softening point of 93° C., an acetone extraction quantity of 2.9% by weight, a penetration hardness of 7 dmm and a shrinkage ratio of 0.34 as shown in Table 1 was obtained.

### Example 3

Polymerization was carried out in the same manner as in Example 1, except that 915 ml of hexane and 85 ml of 4-methyl-1-pentene were placed and hydrogen was fed until the pressure became 0.93 kg/cm² (gauge pressure). As a result, 52.2 g of a polyethylene wax (sample 3) having [η] of 0.22 dl/g, Mw/Mn of 2.9, Mz/Mw of 1.6, a density of 903 kg/m³, a softening point of 103° C., an acetone extraction quantity of 4.2% by weight, a penetration hardness of 5 dmm and a shrinkage ratio of 0.82 as shown in Table 1 was obtained.

### Example 4

Polymerization was carried out in the same manner as in Example 1, except that 910 ml of hexane and 90 ml of 4-methyl-1-pentene were placed and hydrogen was fed until the pressure became 0.88 kg/cm² (gauge pressure). As a result, 44.1 g of a polyethylene wax (sample 4) having [η] of 0.36 dl/g, Mw/Mn of 3.0, Mz/Mw of 1.6, a density of 882 kg/m³, a softening point of 91° C., an acetone extraction quantity of 2.3% by weight, a penetration hardness of 10 dmm and a shrinkage ratio of 0.25 as shown in Table 1 was obtained.

### Comparative Example 1

An ethylene/1-butene copolymer (available from Mitsui Chemicals, Inc., Tafmer A20090) was fed to a single screw extruder and subjected to heat degradation with extruding at 400° C. As a result, a polyethylene wax (sample 5) having [η] of 0.24 dl/g, Mw/Mn of 2.4, Mz/Mw of 1.6, a density of 901 kg/m³, a softening point of 94° C., an acetone extraction quantity of 4.8% by weight, a penetration hardness of 13 dmm and a shrinkage ratio of 1.32 as shown in Table 1 was obtained.

### Comparative Example 2

A high-pressure polyethylene wax (available from Eastman Chemical Company, Epolene C-10P) had, as its properties, [η] of 0.36 dl/g, Mw/Mn of 3.6, Mz/Mw of 3.3, a density of 906 kg/m³, a softening point of 104° C., an acetone extraction quantity of 5.1% by weight, a penetration hardness of 6 dmm and a shrinkage ratio of 0.98.

Properties of the polyethylene waxes described in the above examples and comparative examples are set forth in Table 1.

TABLE 1
(Properties of polyethylene wax)

| Sample | | | | | Comp. | Comp. |
|---|---|---|---|---|---|---|
| No. | Ex. 1 | Ex. 2 | Ex. 3 | Ex. 4 | Ex. 1 | Ex. 2 |
| [η] | 0.24 | 0.39 | 0.22 | 0.36 | 0.24 | 0.36 |
| (dl · g⁻¹) | | | | | | |
| Mw/Mn | 3.1 | 3.6 | 2.9 | 3.0 | 2.3 | 3.6 |
| Mz/Mw | 1.6 | 1.7 | 1.6 | 1.6 | 1.6 | 3.3 |
| Density | 902 | 895 | 903 | 882 | 901 | 906 |
| (kg · m⁻³) | | | | | | |
| Softening | 98 | 93 | 103 | 91 | 94 | 104 |
| point | | | | | | |
| (° C.) | | | | | | |
| Acetone | 4.4 | 2.9 | 4.2 | 2.3 | 4.8 | 5.1 |
| extraction | | | | | | |
| quantity | | | | | | |
| (wt %) | | | | | | |
| Penetration | 6 | 7 | 5 | 10 | 13 | 6 |
| hardness | | | | | | |
| (dmm) | | | | | | |
| Shrinkage | 0.70 | 0.34 | 0.82 | 0.25 | 1.32 | 1.08 |
| ratio (%) | | | | | | |

Next, synthesis examples of polyethylene waxes used in the lost wax compositions for precision casting of the invention are described.

### Synthesis Example 1

Using a metallocene catalyst, a polyethylene wax was synthesized in the following manner. In a 2-liter SUS autoclave thoroughly purged with nitrogen, 970 ml of hexane and 30 ml of propylene were placed, and hydrogen was fed until the pressure became 1.8 kg/cm² (gauge pressure). Subsequently, the temperature in the system was raised to 150° C., and then, 0.3 mmol of triisobutylaluminum, 0.004 mmol of triphenylcarbenium tetrakis(pentafluorophenyl)borate and 0.02 mmol of (t-butylamido)dimethyl(tetramethyl-η⁵-cyclopentadienyl)silanetitanium dichloride (available from Sigma Aldrich Corporation) were forced into the autoclave with ethylene to initiate polymerization. Thereafter, only ethylene was continuously fed to maintain the total pressure at 30 kg/cm² (gauge pressure), and polymerization was performed at 150° C. for 20 minutes.

After a small amount of ethanol was added to the system to terminate the polymerization, the unreacted ethylene and propylene were purged away. The resulting polymer solution was dried overnight at 100° C. under reduced pressure. As a result, 85.5 g of a polyethylene wax having [η] of 0.07 dl/g, a density of 920 kg/m³, a softening point of 109° C. and Mw/Mn of 1.9 was obtained.

The above synthesis was repeated 10 times, and the metallocene waxes synthesized by the syntheses of 10 times were melt mixed. Then, the mixture was cooled to give a sample 1.

### Synthesis Example 2

Synthesis was carried out in the same manner as in Synthesis Example 1, except that 960 ml of hexane and 40 ml of propylene were placed and hydrogen was fed until the pressure became 1.3 kg/cm². As a result, 60.3 g of a polyethylene wax having [η] of 0.13 dl/g, a density of 922 kg/m³, a softening point of 105° C. and Mw/Mn of 2.4 was obtained.

The above synthesis was repeated 10 times, and the metallocene waxes synthesized by the syntheses of 10 times were melt mixed. Then, the mixture was cooled to give a sample 2.

### Example 5

In a stainless steel container, 30 parts of a C5 aliphatic unsaturated hydrocarbon petroleum resin (available from Mitsui Chemicals, Inc., Hi-rez T500, number-average molecular weight: 1200), 20 parts of a rosin resin (available from Harima Kasei Kogyo K.K., Hariester C), 40 parts of a paraffin wax (available from Nippon Seiro Co., Ltd., Paraffin Wax 135) and 10 parts of the polyethylene wax (sample 1) were placed, and they were melted by heating at a temperature of 120 to 130° C. for 20 to 30 minute and sufficiently stirred by an Ajiter type stirring machine to obtain a lost wax composition.

### Example 6

A lost wax composition was obtained in the same manner as in Example 1, except that the sample 2 was used as a polyethylene wax.

### Example 7

A lost wax composition was obtained in the same manner as in Example 1, except that low-molecular weight polyethylene HW210P (available from Mitsui Chemicals, Inc.) was used as a polyethylene wax.

### Example 8

A lost wax composition was obtained in the same manner as in Example 1, except that oxidation type low-molecular weight polyethylene HW210 MP (available from Mitsui Chemicals, Inc.) was used as a polyethylene wax.

### Comparative Example 3

A lost wax composition was obtained in the same manner as in Example 1, except that 10 parts of the polyethylene wax used in Example 1 were replaced with 10 parts of low-molecular weight polyethylene HW4202E (available from Mitsui Chemicals, Inc.).

### Comparative Example 4

A lost wax composition was obtained in the same manner as in Example 1, except that 10 parts of the polyethylene wax used in Example 1 were replaced with 10 parts of low-molecular weight polyethylene HW400P (available from Mitsui Chemicals, Inc.).

### Comparative Example 5

A lost wax composition was obtained in the same manner as in Example 1, except that 40 parts of the paraffin wax and 10 parts of the polyethylene wax (total: 50 parts) used in Example 1 were replaced with 50 parts of a paraffin wax.

Properties of the lost wax compositions of Examples 5 to 8 and Comparative Examples 3 to 5 and properties of the polyethylene waxes used are set forth in Table 2 and Table 3, respectively.

TABLE 2
(Formulation and properties of lost wax composition)

| | | | | | | Comp. | Comp. | Comp. |
|---|---|---|---|---|---|---|---|---|
| | | Ex. 5 | Ex. 6 | Ex. 7 | Ex. 8 | Ex. 3 | Ex. 4 | Ex. 5 |
| Formulation of lost wax | C5 type | 30 | 30 | 30 | 30 | 30 | 30 | 30 |
| composition (part(s)) | petroleum resin | | | | | | | |
| | (Hi-rez T500) | | | | | | | |
| | Rosin resin | 20 | 20 | 20 | 20 | 20 | 20 | 20 |
| | (Hariester C) | | | | | | | |
| | Paraffin wax | 40 | 40 | 40 | 40 | 40 | 40 | 50 |
| | (Paraffin Wax | | | | | | | |
| | 135) | | | | | | | |
| | Polyethylene | | | | | | | |
| | wax | | | | | | | |
| | Sample 1 | 10 | | | | | | |
| | Sample 2 | | 10 | | | | | |
| | HW210P | | | 10 | | | | |
| | HW210MP | | | | 10 | | | |
| | HW4202E | | | | | 10 | | |
| | HW400P | | | | | | 10 | |
| Property values | Softening point | 73 | 69 | 77 | 77 | 72 | 88 | 64 |
| | (° C.) (JIS | | | | | | | |
| | K2207) | | | | | | | |
| | Penetration | 2 | 2 | 1 | 1 | 2 | 1 | 4 |
| | hardness (dmm) | | | | | | | |
| | (JIS K2207) | | | | | | | |
| | Melt viscosity | 18 | 32 | 31 | 32 | 41 | 78 | 8 |
| | (mPa · s) | | | | | | | |
| | (140° C., B type | | | | | | | |
| | viscometer) | | | | | | | |
| | Flexural | 70 | 78 | 85 | 84 | 80 | 108 | 45 |
| | strength (kg · cm⁻³) | | | | | | | |
| | (JIS K6911) | | | | | | | |

TABLE 3
(Properties of polyethylene wax)

| Property | Polyethylene wax | | | | | |
|---|---|---|---|---|---|---|
| items | Sample 1 | Sample 2 | HW210P | HW210MP | HW4202E | HW400P |
| Melt | 15 | 80 | 80 | 80 | 300 | 650 |
| viscosity | | | | | | |
| (mPa · s) | | | | | | |
| [η] | 0.07 | 0.13 | 0.13 | 0.13 | 0.17 | 0.26 |
| (dl · g⁻¹) | | | | | | |
| Density | 920 | 922 | 940 | 940 | 950 | 978 |
| (kg · m⁻³) | | | | | | |
| Softening | 109 | 105 | 120 | 118 | 107 | 136 |
| point (° C.) | | | | | | |
| Penetration | 7 | 7 | 4 | 3 | 5 | 1 |
| hardness | | | | | | |
| (dmm) | | | | | | |
| Acid value | 0 | 0 | 0 | 1 | 20 | 0 |
| (KOHmg · g⁻¹) | | | | | | |
| Mw/Mn | 1.9 | 2.4 | 3.0 | 3.0 | 5.2 | 2.8 |

As shown in Table 2, the lost wax compositions of Examples 5 to 8 and Comparative Examples 3 and 4 were very excellent in the flexural strength. However, the lost wax composition of Comparative Example 3 had a very high melt viscosity, so that the molding conditions are restricted.

Injection Molding Test

Using the lost wax compositions of Examples 5 to 8 and Comparative Examples 3 to 5, injection molding tests were carried out under the following conditions.

Molding Conditions

Wax temperature at the time of injection

68° C.: lost wax compositions of Examples 1 to 4 and Comparative Example 1

80° C.: lost wax composition of Comparative Example 2

58° C.: lost wax composition of Comparative Example 3

Injection pressure: 30 kg/cm²

Injection retention time: 10 seconds

Shape of wax model (molded product)

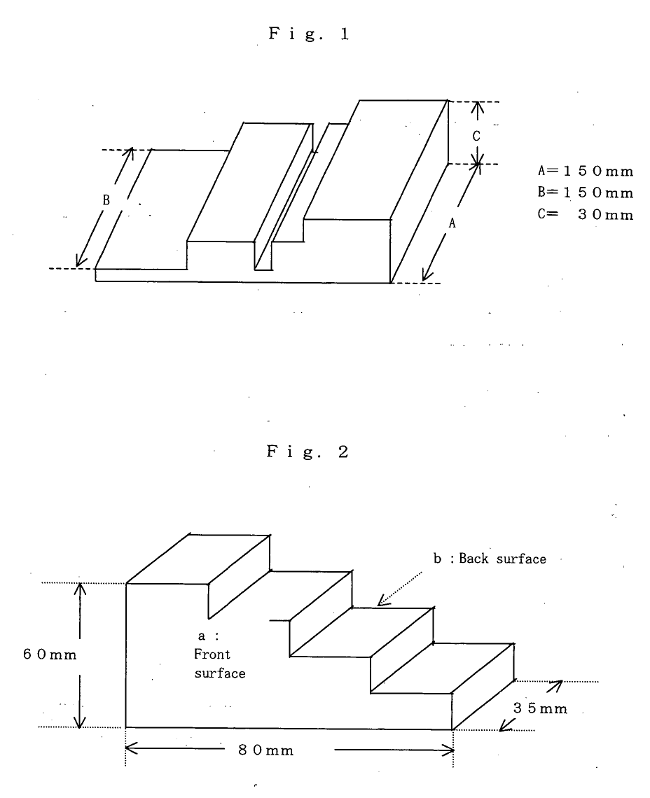

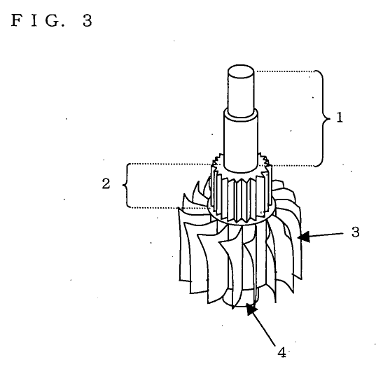

As shown in FIG. 1 and FIG. 2, two types of a model for dimension measurement and a model for sink mark measurement were prepared, and five models for each type were formed.

Each of the lost wax models obtained was allowed to stand for 24 hours in a constant temperature room at 25° C., and when the dimensions were stabilized, shrinkage ratio (%) and sink mark (m/m) were measured. The shrinkage ratio was determined as follows. The lengths of the A, B and C parts of the model for dimension measurement were measured by means of a slide gauge, and from differences between the measured lengths and the dimensions of the mold, each shrinkage ratio was calculated. The sink mark was determined as follows. Each depth (m/m) of the most depressed parts of the surface a and the surface b on the basis of their peripheries was measured by means of a dial gauge. The solidification shrinkage ratio and the sink mark are each an average of measured values of the five models. Further, flow lines and involvement of bubbles on the surface of each model were observed with the naked eye. The results are set forth in Table 4.

TABLE 4

| | Location of | | | | | Comp. | Comp. | Comp. |
|---|---|---|---|---|---|---|---|---|
| | measurement | Ex. 5 | Ex. 6 | Ex. 7 | Ex. 8 | Ex. 3 | Ex. 4 | Ex. 5 |
| Shrinkage | A part | 0.81 | 0.72 | 0.80 | 0.73 | 0.84 | 0.96 | 0.88 |
| ratio (%) | B part | 0.41 | 0.34 | 0.31 | 0.28 | 0.42 | 0.56 | 0.42 |
| | C part | 0.79 | 0.72 | 0.72 | 0.71 | 0.81 | 0.88 | 0.78 |
| | Xs | 0.67 | 0.59 | 0.61 | 0.57 | 0.69 | 0.80 | 0.65 |
| Sink mark | Surface a | 0.37 | 0.29 | 0.31 | 0.26 | 0.44 | 0.58 | 0.39 |
| (m/m) | Surface b | 0.33 | 0.31 | 0.32 | 0.29 | 0.40 | 0.57 | 0.34 |
| | Xm | 0.35 | 0.30 | 0.32 | 0.28 | 0.42 | 0.58 | 0.37 |
| Model texture | Flow lines | few | none | none | none | few | few | few |
| | Involvement | none | none | none | none | few | many | none |
| | of bubbles | | | | | | | |

| | | | | | | | |
|---|---|---|---|---|---|---|---|
| Releasability | 12 | 16 | 16 | 18 | 11 | 12 | 6 |
| Shell cracking | small | small | small | small | medium | large | small |

As shown in Table 4, the lost wax compositions of Examples 5 to 8 and Comparative Example 5 had small values of solidification shrinkage ratio and sink mark, and this indicates the dimensional accuracy is stable. Further, they rarely suffered flow lines and involvement of bubbles, and they had excellent surface texture.

Cast Article Forming Test

Using the wax compositions of Examples 1 to 4 and Comparative Examples 1 to 3, impeller models of complicated shapes having a shaft 1, a gear 2, a blade 3, a bottom 4 and a semispherical depression 5 as shown in FIG. 3 were formed by means of an injection molding machine. The injection molding was carried out under the injection conditions of a wax temperature of 65° C., an injection pressure of 30 kg/cm² and an injection retention time of 10 seconds.

Then, using the resulting models, precision cast articles were produced. That is to say, each wax model was immersed in a slurry comprising colloidal silica, water, a zircon flour, molten silica and a mullite flour, and before the slurry was dried, sands comprising a zircon flour, zircon sands, alumina sands and a mullite flour were sprinkled. After these operations were repeated 6 times, the wax model was coated with a final slurry and dried at 25° C. Thereafter, the wax model was melted by heating at a temperature of 150 to 160° C. and a pressure of 7 to 9 kg/cm² for 10 minutes in an autoclave, and the molten wax composition was discharged to form a casting mold. Cracking on the inner or outer surfaces of the casting mold (shell cracking) was visually observed. Thereafter, the casting mold was burned at 1050° C. for 1 hour, and a molten metal of stainless steel (SUS 304) was immediately cast into the casting mold, followed by operations of shake-out, gate cutting and finishing. Thus, a cast article was obtained.

Releasability from the mold and results of observation of shell cracking are set forth in Table 4.

The releasability and the shell cracking were evaluated by the following methods.

Releasability

After the mold is washed with a solvent, molding operations are continuously carried out, and the number of wax models at the last of which withdrawal of the wax model from the mold becomes infeasible is counted. As the releasability, an average of the experiments of 3 times is set forth.

Shell Cracking

large: An extremely large number of shell cracks are observed.

medium: A fairly large number of shell cracks are observed.

small: Shell cracks rarely occur.

As shown in Table 4, the lost wax compositions of Examples 5 to 8 and Comparative Examples 3 and 4 were excellent in the releasability. Further, the lost wax compositions of Examples 5 to 8 and Comparative Example 5 rarely suffered shell cracking.

### INDUSTRIAL APPLICABILITY

The polyethylene wax of the invention has low shrinkage ratio, high hardness and low tackiness, so that it can be favorably used for hot melts, lost waxes and the like.

The lost wax composition containing the polyethylene wax of the invention has the following advantages:

dimensional accuracy is high, that is, solidification shrinkage ratio and sink mark (depression of smooth surface) are small; releasability from a mold is excellent; surface texture of a wax mold is excellent; fluidity is excellent; recovery after use and recycling of many times are feasible; flexural strength is high; and shell cracking occurs very little in the formation of a casting mold.

1. A polyethylene wax defined by the following features (i) to (iv):
(i) said polyethylene wax is an ethylene homopolymer or a copolymer of ethylene and at least one olefin selected from α-olefins of 3 to 20 carbon atoms,
(ii) a ratio (Mw/Mn) of the weight-average molecular weight (Mw) to the number-average molecular weight (Mn), as measured by gel permeation chromatography (GPC), is in the range of 1.7 to 4.0,
(iii) the softening point is not higher than 125° C., and
(iv) the penetration hardness is not more than 15 dmm.

2. The polyethylene wax as claimed in claim 1, which is a copolymer of ethylene and at least one olefin selected from α-olefins of 3 to 20 carbon atoms and has a ratio (Mw/Mn) of a weight-average molecular weight (Mw) to a number-average molecular weight (Mn), as measured by gel permeation chromatography (GPC), of 2.6 to 4.0, a softening point of not higher than 110° C., a penetration hardness of not more than 15 dmm, an intrinsic viscosity [η] as measured in decalin at 135° C., of 0.15 to 0.50 dl/g, a ratio (Mz/Mw) of a z-average molecular weight (Mz) to a weight-average molecular weight (Mw), as measured by gel permeation chromatography (GPC), of 1.5 to 2.0, a density of 880 to 910 kg/m³ and an acetone extraction quantity of not more than 6% by weight, wherein the softening point (Ts (° C.)) and the penetration hardness (Y (dmm)) satisfy the following relationship (I):
−0.53Ts+62>Y>−0.53Ts+53 (I).

3. The polyethylene wax as claimed in claim 1, which is an ethylene homopolymer or a copolymer of ethylene and at least one olefin selected from α-olefins of 3 to 20 carbon atoms and has a ratio (Mw/Mn) of a weight-average molecular weight (Mw) to a number-average molecular weight (Mn), as measured by gel permeation chromatography, of 1.7 to 3.3, a softening point of 88 to 125° C., a penetration hardness of not more than 7 dmm and an intrinsic viscosity [η], as measured in decalin at 135° C., of 0.05 to 0.20 dl/g.

4. The polyethylene wax as claimed in claim 1, which is prepared by the use of a metallocene catalyst.

5. A lost wax composition for precision casting, comprising a polyethylene wax defined by the following features (i) to (iv):
(i) said polyethylene wax is an ethylene homopolymer or a copolymer of ethylene and at least one olefin selected from α-olefins of 3 to 20 carbon atoms,
(ii) a ratio (Mw/Mn) of the weight-average molecular weight (Mw) to the number-average molecular weight (Mn), as measured by gel permeation chromatography (GPC), is in the range of 1.7 to 4.0,
(iii) the softening point is not higher than 125° C., and
(iv) the penetration hardness is not more than 15 dmm.

6. The lost wax composition for precision casting as claimed in claim 5, wherein the polyethylene wax is an ethylene homopolymer or a copolymer of ethylene and at least one olefin selected from α-olefins of 3 to 20 carbon atoms and has a ratio (Mw/Mn) of a weight-average molecular weight (Mw) to a number-average molecular weight (Mn), as measured by gel permeation chromatography, of 1.7 to 3.3, a softening point of 88 to 125° C., a penetration hardness of not more than 7 dmm and an intrinsic viscosity [η], as measured in decalin at 135° C., of 0.05 to 0.20 dl/g.

7. The lost wax composition for precision casting as claimed in claim 5, wherein the content of the polyethylene wax is in the range of 5 to 50% by weight.

8. The lost wax composition for precision casting as claimed in claim 5, wherein the polyethylene wax has an acid value of 0.5 to 5.0 KOH·mg/g.

9. A method for forming a model for precision molding, using the lost wax composition for precision casting of claim 5.
